(19) United States
(12) Patent Application Publication
(10) Pub. No.: US 2026/0316376 A1
(43) Pub. Date: Oct. 15, 2026

(54) METHOD FOR THREE-DIMENSIONAL PRINTING OF FIBER COMPOSITE MATERIALS

(71) Applicant: MOI COMPOSITES S.R.L., Milano (IT)

(72) Inventors: Tommaso GERI, Montescudaio (IT); Giovanni Maria MINARI, Rovato (IT); Gabriele NATALE, Supersano (IT); Michele TONIZZO, Codroipo (IT)

(21) Appl. No.: 19/119,114

(22) PCT Filed: Oct. 9, 2023
(86) PCT No.: PCT/IB2023/060105

§ 371 Date: Apr. 8, 2025

(30) Foreign Application Priority Data
Oct. 11, 2022 (IT) 102022000020922

(51) Int. Cl. B29C 64/118; B29C 64/295; B29C 70/38; B33Y 10/00; B33Y 70/10

(52) U.S. Cl. CPC B29C 64/118; B29C 64/295; B29C 70/382; B33Y 10/00; B33Y 70/10

(57) ABSTRACT

A method for the three-dimensional printing of composite materials is described, comprising the steps of:—feeding at least one continuous filiform element (4) to a feeding head (7); said continuous filiform element (4) comprising at least one dispersed phase (3) and at least one continuous phase (2) reacting by means of frontal polymerization reactions;—depositing said continuous filiform element (4) on a supporting surface (9);—supplying, to said continuous filiform element (4), an amount of energy (5) so as to bring said at least one continuous phase (2) to an initiation temperature so as to initiate a front of frontal polymerization reaction in said at least one continuous phase (2);—supplying, to said continuous filiform element (4), said amount of energy (5) in a repeated manner and at different positions along its extent, during the depositing step, so as to generate initiations of different fronts of frontal polymerization reaction.

### FIELD OF THE INVENTION

The present invention relates to the field of three-dimensional printing of composite materials.

In particular, the present invention concerns equipment and a method for three-dimensional printing of fiber composite materials and thermoplastic or thermosetting matrix.

### KNOWN ART

As known, the term “composite” generally means a material obtained by combining two or more components so that the final product has properties different from those of the individual constituents. In order to better identify what is meant by the term “composite” in the technical field, it is customary to limit the class of composite materials to reinforced materials only, in which at least one component, usually in the form of fibers, has much greater mechanical characteristics than the others.

Generally, the join, by adhesion or cohesion, of two or more components different in shape and chemical composition, which are insoluble in each other and separated by an interface, can be defined as “composite material” or simply “composite”.

The composite materials generally are constituted by a continuous phase (named matrix) and a dispersed phase (often in the form of a reinforcing element). The mechanical properties of the material (strength and rigidity) are mainly entrusted to the dispersed phase, whereas the task of transferring the external loads applied to the dispersed phase is entrusted to the continuous phase. This transmission occurs as a result of shear stresses acting at the interface between dispersed phase and continuous phases. Moreover, in addition to stabilizing the composite by compression, the matrix has the task of holding together and protecting the fibers and of shaping the piece.

Ultimately, a composite material is a multiphase material which can be created artificially and which is different from the constituents: depending on the principle of the combined actions, the optimization of a property is obtained by means of the careful and designed combination of two or more different materials.

Depending on the material of the matrix constituting the continuous phase, the composites are classified as a metal matrix, a ceramic matrix and a polymer matrix.

The polymer matrix composite materials generally consist of synthetic fibers (for example carbon, nylon, aramid or glass) embedded in a polymer matrix which surrounds, protects and binds the fibers. Typically, fibers constitute about 50/60% by volume of a polymer matrix composite.

In turn, there are two subclasses of materials composing the polymer matrix within the polymer matrix category, these are: thermoplastic polymers and thermosetting polymers.

The thermoplastic polymers are a group of plastic materials which gain malleability under the action of temperature. Subjected to the action of temperature, the thermoplastic polymers can be molded or shaped into finished objects and can, thus, return to being rigid structures once cooled. In fact, the viscosity decreases with the increasing of temperature but also with the increasing of the shear rate and shear stress. This heating/cooling cycle can theoretically be repeated several times depending on the qualities of the different plastic materials; in practice, it is possible to repeat the cycle for a limited number of times since too many heating cycles can degrade the polymers.

The thermosetting polymeric materials have a cross-linked molecular structure formed by covalent bonds. The thermosetting polymers are cross-linked by means of a process named “Curing,” through which the resin undergoes a series of chemical transformations in the fluid state, passing through a gelled or rubbery state until passing to the vitreous state. Some thermosetting resins are cross-linked by means of heat or through heat and pressure combined. In other cases, the chemical reaction can occur at room temperature (cold thermosets) by means of light radiation, evaporation of substances, activation by means of moisture and, finally, due to the forced mixing of two elements (generally resin and catalyst).

Although thermosetting resin artifacts can soften as a result of the heat (Tg, glass transition temperature), the covalent bonds in the lattice prevent them from returning to the fluid state that existed before cross-linking; if heating results in exceeding the degradation temperature they rather decompose by carbonizing. The thermosetting materials cannot thus be reheated and thus melted as occurs with thermoplastics.

Processes for the three-dimensional printing of composite materials are for example described in U.S. Pat. Nos. 9,987,798, 10,011,073 and 9,126,367.

The Applicant noted that three-dimensional printing processes of known fiber composite materials have limitations in the type of material and/or process that can be used. For example, the Applicant noted that in the case of thermosetting monomers capable of photopolymerization as a result of electromagnetic radiation, the choice is often limited, e.g., opaque reinforcing fibers (e.g., carbon fiber, basalt fiber, aramid fiber etc.) cannot be used. Another limitation in this case is the thickness that can be used, which cannot be too high.

The above two limitations results in deficiencies in the homogeneity and quality of the resulting product.

Furthermore, the Applicant has noted that, with reference to epoxy resins, they are often characterized by significant kinetic limitations, in other words, the reactions that produce the polymer are very slow, therefore, such as to make these materials poorly usable in three-dimensional printing processes.

### SUMMARY OF THE INVENTION

Therefore, in its first aspect, the invention concerns a method for the three-dimensional printing of composite materials, comprising the steps of:
feeding at least one continuous filiform element to a feeding head; said continuous filiform element comprising at least one dispersed phase, preferably comprising a thermally conductive material and at least one continuous phase reacting by means of frontal polymerization reactions;
depositing said continuous filiform element on a supporting surface;
supplying, to said continuous filiform element, an amount of energy so as to bring said at least one continuous phase to an initiation temperature so as to initiate a front of frontal polymerization reaction in said at least one continuous phase;
supplying, to said continuous filiform element, said amount of energy in a repeated manner and at different positions along its extent, during the depositing step, so as to initiate different polymerization fronts.

For the purposes of this invention, the following definitions apply:

By “frontal polymerization and/or frontal-type polymerization” is meant a polymerization reaction in which the polymerization, i.e., the chemical reaction that leads to the formation of a polymer chain from simpler molecules called monomers, occurs directionally and through the propagation from a localized reaction site [J. A. Pojman, “Frontal Polymerization,” in Polymer Science: A Comprehensive Reference, Elsevier, 2012, pp. 957-980.]. Such reaction occurs as a result of an initiation in the form of a localized stimulus and, once initiated, propagates in the material by the action of the reaction enthalpy, without the need for further energetic stimuli. In frontal photopolymerization processes, the heat generated by the reaction itself in the propagation step of polymer chain becomes driving force for the propagation of the reaction itself, due to the activation of thermal initiator species upon reaching an initiation temperature [F. Petko, A. Świeży, and J. Ortyl, “Photoinitiating systems and kinetics of frontal photopolymerization processes—the prospects for efficient preparation of composites and thick 3D structures,” Polym. Chem., vol. 12, no. 32, pp. 4593-4612, 2021, doi: 10.1039/D1PY00596K.]. In particular, the activation of thermal initiator species, defined as those chemical species capable of producing reactive species by the action of temperature, is made possible by reaching said initiation temperature, which is characteristic of the specific thermal initiator species under consideration. Furthermore, it is evident that monomeric species capable of resulting in frontal polymerization reaction show strongly exothermic reactions, thus capable of promoting the propagation of the reaction front.

By “preliminary polymerization” is meant a polymerization of at least part of the filiform element that occurs at a time prior to and/or at a place prior to feeding the filiform element to the feeding head.

By “initiation temperature” is meant, in the context of a frontal polymerization, the temperature at which the activation of the thermal initiator species occurs, that is, the temperature at which the rapid decomposition of said initiator into reactive chemical species is favored, thus capable of initiating a polymerization reaction.

By “photosensitizing material and/or simply photosensitizer” is meant a chemical species that, when invested by electromagnetic radiation, is able to absorb it, bringing itself into an excited state. In this state, the photosensitizing species is able to transfer energy (e.g., by electron transfer or charge transfer mechanisms) to a photoinitiator, causing it to be activated and consequently producing reactive chemical species. The use of photosensitizers can be necessary in the case where a photoinitiator is unable to absorb radiation and, therefore, to activate itself independently, in the electromagnetic spectrum provided by the electromagnetic radiation source employed in place of the source of the energy stimulus. The use of photosensitizers can be convenient in the case where the radiation absorption process of the photoinitiator in the electromagnetic spectrum provided by the electromagnetic radiation source employed in place of the source of the energy stimulus is poorly efficient.

By “photoinitiator” is meant a chemical species capable of producing different, reactive chemical species as a result of the absorption of electromagnetic radiation, typically in the ultraviolet or visible electromagnetic spectrum. In the case of systems capable of photopolymerizing as a result of electromagnetic radiation, with reference to the set or mixtures of monomeric species, photoinitiators and possible synergistic-acting compounds, there are two main chemical processes of industrial relevance: radical and cationic processes. In the former case, the absorption of radiation by the initiator results in the production of reactive radicals. In the second case, the absorption of radiation by the initiator results in the production of Brønsted or Lewis acids, which are consequently capable of initiating a ring-opening polymerization process, i.e., the type of chain polymerization reaction in which the reactive terminal of polymer chain undergoing the accretion step chemically attacks a cyclic-terminated monomer to form a longer polymer chain.

By “cationic initiator” is meant a chemical species capable of producing different and reactive chemical species, such as, for example, Brønsted acids or Lewis acids, as a result of a photochemical or chemical stimulus. In particular, the term cationic initiator refers to those chemical species capable of initiating cationic chain polymerization processes as a result of charge transfer between the initiator itself and the precursor monomer of the polymer being formed, in turn making it reactive toward other monomers. The production of reactive species can occur as a result of direct absorption of radiation, typically in the ultraviolet electromagnetic spectrum, by the species of cationic initiator or as a result of oxidation reactions that occur in the presence of other reactive species and participating in the reaction such as, for example, radical species.

By “synergistic action compound” is meant the element of a photopolymerizable mixture conveniently added to improve the photoactivity of the mixture itself compared with the case of single use of the component materials of said mixture. The synergistic effect is reflected in the improved efficiency of the system in the radiation absorption step, polymerization reaction step, or both. For example, using combinations of different photoinitiators inside a mixture can enable the use of different energy sources. The addition of elements such as amines or thiols can mitigate the reaction inhibition effects caused by the presence of atmospheric oxygen, which is a known cause of poor efficiency of radical photopolymerization reactions.

The present invention, in the aforementioned aspect, can have at least one of the preferred characteristics hereinafter described.

Preferably, the amount of energy is applied directly to the continuous phase.

Conveniently, the amount of energy is applied to the dispersed phase so as to bring said at least one continuous phase to the initiation temperature.

Advantageously, the method comprises:
spreading at least one end of the continuous filiform element on a respective supporting surface;
subjecting said end of said filiform element to an amount of energy so as to bring said at least one continuous phase to an initiation temperature so as to initiate a front of frontal polymerization reaction in said at least one continuous phase;
displacing said feeding head relative to the fixing point according to a predetermined path that defines the object to be printed.

Said amount of energy can be supplied to heat said continuous phase directly or to heat said dispersed phase.

Said amount of energy can be supplied by means of electromagnetic radiation sources.

Conveniently, said electromagnetic radiation is selected from the infrared spectrum.

Conveniently, the feeding and depositing steps are implemented by exerting a tensile force on the continuous filiform element by relative movement between a respective feeding head and the supporting surface or, by extrusion.

Advantageously, said at least one dispersed phase comprises a fiber material selected from carbon fibers, glass fibers, poly paraphenylene terephthalamide fibers, ultra-high molecular weight polyethylene (UHMWPE) fibers, poly arylether ketone (PAEK) fibers, poly paraphenylene-2,6-benzobisoxazole fibers, poly ether sulfone (PES) fibers, beryllium fibers, tungsten fibers, carbon nanofibers, silicon carbide (SiC) fibers, boron fibers, poly imide (PI) fibers, poly benzimidazole fibers, poly oxymethylene (POM) fibers, poly ether imide (PEI) fibers, fibers made of metal alloy, basalt fibers, natural fibers, and combinations thereof and similar materials.

Said at least one dispersed phase can comprise a material which is pulverulent or in the form of nanostructures.

Preferably, the pulverulent material is selected from carbon black, silicon dioxide, graphite, titanium oxide, boron nitride, zirconium oxide, calcium carbonate, calcium phosphate, molybdenum disulfide, lignin and combinations thereof and the like.

Preferably, the material in the form of nanostructures is selected from graphene, single-walled carbon nanotubes, multi-walled carbon nanotubes, fullerene, clay nanoplates and combinations thereof and the like.

Conveniently, the continuous phase comprises at least one first compound comprising:
a thermal initiator in an amount greater than or equal to about 0.001 mol % and lower than or equal to about 10 mol %;
a first monomer in an amount greater than or equal to about 20 mol % and lower than or equal to about 99.9 mol %;
a cationic initiator in an amount greater than or equal to about 0.001 mol % and lower than or equal to about 10 mol %; and
a first diluent in an amount greater than or equal to about 0 mol % and lower than or equal to about 70 mol %.

Advantageously:
said thermal initiator is selected from the group constituted by: 1,1,2,2-tetraphenyl-1,2-ethanediol (TPED), benzopinacol bistrimethylsilyl ether (TPED-Si), dimethylsulfonylperoxide (DMSP), tert-butylperoxide (TBPO), tert-butylcyclohexylperoxodicarbonate (TBC-PDC), benzoylperoxide (BPO), azo-bis(isobutyronitrile) (AIBN) and combinations thereof and the like;
the first monomer is selected from the group constituted by: bisphenol A diglycidylether (DGEBA), bisphenol F diglycidylether (DGEBF), 3,4-epoxycyclohexylmethyl 3,4-epoxycyclohexanecarboxylate (CE), 4-vinyl-1-cyclohexan-1,2-epoxide, vinylcyclohexene bioxide, 4,5-epoxy tetrahydrophthalic acid diglycidylester, glycidyl methacrylate, pentaerythritol glycidyl ether, trimethylolpropane triglycidyl ether, 2-(3,4-epoxycyclohexyl)ethyltrimethoxysilane, poly(ethylenglycol) diglycidyl ether, epoxidized soybean oil, N,N-diglycidyl-4-glycidyloxyaniline, bis-3,4-epoxycyclohexylmethyladipate, diglycidyl 1,2-cyclohexane dicarboxylate, allyl glycidyl ether, phenyl glycidyl ether, diglycidyl 4,5-epoxycyclohexan-1,2-dicarboxylate, 4,4″-methylenebis[N,N-bis(2,3-epoxypropyl)aniline], tris(2,3-epoxypropyl) isocyanurate, m-(2,3-epoxypropoxy)-N,N-bis( 2,3-epoxypropyl)aniline, p-(2,3-epoxypropoxy)-N,N-bis(2,3-epoxypropyl)aniline, triethoxy(3-glycidyl oxypropyl)silane, 1,2-epoxycyclohexane, tris(4-hydroxyphenyl)methane triglycidylether, epoxy-phenolic resins (including those derived from novolacs), 9-[2-(2-methoxyethoxy)ethoxy]-9-[3-(oxyranylmethoxy)propyl]-2,5,8,10,13,16-hexaoxa-9-silaheptadecane, glycidyl stearate, resorcinol diglycidylether, 1,4-butanediol diglycidyl ether (BDGE), vinyl ethers, epoxy-phenolic resins (including those derived from dicyclopentadiene), carboxyl-terminated butadiene acrylonitrile rubber (CTBN), epoxy-terminated butadiene acrylonitrile rubber (ETBN) and combinations thereof and the like;

the cationic initiator is selected from the group consisting of: [4-(4-diphenylsulfoniumphenyl)sulfonylphenyl]-diphenylsulfonium trihexafluorophosphate, (4-methylphenyl) [4-(2-methylpropyl)phenyl]iodonium hexafluorophosphate, (9-oxofluoren-2-yl)-phenyliodonium hexafluoroantimonate, [4-(4-diphenylsulfoniumphenyl)sulfonylphenyl]-diphenylsulfonium hexafluoroantimonate, [4-[(2-hydroxytetradecyl)oxy]phenyl] phenyliodonium hexafluoroantimonate, 4-octyloxydiphenyliodonium hexafluoroantimonate, 10-(4-phenylphenyl)-2-propan-2-ylthioxanthen-10-ium-9-one hexafluorophosphate, bis(4-dodecylphenyl)iodonium hexaflurorantimonate, bis-(4-t-butylphenyl)iodonium hexafluorophosphate, bis[4-(tert-butyl)phenyl]iodonium tetra(nonafluoro-tert-butoxy) aluminate, diphenyl(4-phenylthio)phenylsulfonium hexafluorophosphate, diphenyliodonium hexafluorophosphate, bis(4-methylphenyl)iodonium hexafluorophosphate, (4-methylphenyl)[4-(propan-2-yl)phenyl]iodonium tetrakis(2,3,4,5,6-pentafluorophenyl) borate and combinations thereof; and
the first diluent is selected from the group constituted by: polyfunctional glycidyl ethers, monofunctional aliphatic glycidyl ethers, monofunctional aromatic glycidyl ethers, 3-ethyl-3-oxethanemethanol (EOM), 3-Methyl-3-oxethanemethanol, 1,4-bis(glycidyloxy)benzene (CHDGE), 1,6-hexanediol diglycidylether (HDDGE), neopentyl glycol diglycidyl ether (NPDGE), 1,4-butanediol diglycidyl ether (BDGE) and combinations thereof.

Preferably, the first compound can include a photosensitizing material.

Advantageously, the photosensitizing material is present in an amount greater than or equal to about 0.001 mol % and lower or equal to about 5 mol %.

Preferably, the photosensitizing material is selected in the group consisting of: anthracene, perylene, benzophenone, 9,10-diethoxyanthracene, 2,2-dimethoxy-2-phenylacetophenone, 2-isopropylthioxanthone (ITX), thioxanthen-9-one, vinylcarbazole and combinations thereof.

Alternatively, said amount of energy is supplied by electromagnetic radiation selected in the ultraviolet spectrum.

Alternatively, said energy is supplied by means of energy sources operating by convection.

According to an alternative embodiment, the continuous phase can comprise at least one second compound comprising:
a photo-initiator in an amount greater than or equal to about 0.01 mol % and lower than or equal to about 10 mol %;
a second monomer in an amount greater than or equal to about 20 mol % and lower than or equal to about 99.9 mol %;

advantageously the second compound further comprises:
a compound with synergistic action in an amount greater than or equal to 0 mol % and lower than or equal to about 50 mol %;
a second diluent in an amount greater than 0 mol % and lower than or equal to about 70 mol %.

Preferably, the second compound is present in an amount greater than or equal to 0.1 mol % and lower or equal to 20 mol %. Conveniently, said second compound undergoes a step of preliminary polymerization upstream of the feeding head. Advantageously, the second diluent is selected from the group constituted by: neopentyl acrylate, 3-methyl-1,5-pentanediol diacrylate, 1,6-hexanediol diacrylate, 2-ethylhexyl acrylate, 2-methoxyethyl acrylate and combinations thereof and the like. Preferably the compound with synergistic action is selected from the group constituted by molecules exhibiting amine groups comprising triethylamine, tri-N-butylamine, 2-dimethylaminoethanol, N-methyldiethanolamine, triethanolamine, 2-(dimethylamino)ethyl benzoate, ethyl 4-(dimethylamino)benzoate, 2-ethylhexyl-4-dimethylamino-benzoate, isoamyl-4-(dimethylamino)-benzoate, 2-butoxyethyl-4-(dimethylamino)-benzoate, N-phenylglycine, 4,4′,4″-tris(dimethylamino)-triphenylmethane and combinations thereof and the like, or by the group constituted by molecules exhibiting thiol groups, comprising butyl 3-mercaptopropionate, trimethylolpropane tris(2-mercaptoacetate), trimethylolpropane-tris(2-mercaptopropionate), 2-benzothiazolethiol, 2-benzimidazolol, 1,6-hexane bis(3-mercaptopropionate), di[trimethylolpropane tri(3-mercaptopropionate)], pentaerythritol tetrakis (3-mercaptobutyrate), 1,4-butanediyl bis(3-mercaptobutyrate), trimethylol propane tris (3-mercaptobutyrate) and combinations thereof and the like. Advantageously, the photoinitiator is selected from the group constituted by: 2-hydroxy-2-methyl-propiophenone, 2,2-dimethyl-2-hydroxyacetophenone, 2-hydroxy-2-methyl-1-phenylpropanone, 2-hydroxy-2-methyl-4′-tert-butyl-propiophenone, 2-hydroxy-2-methyl-1-(4-tertbutylphenyl)-propanone, 1-hydroxycyclohexylphenylketone, 2-hydroxy-4′-(2-hydroxyethoxy)-2-methyl-propiophenone, 2-hydroxy-[4′-(2-hydroxypropoxy)]-2-methyl-propiophenone, 2-hydroxy-[4′-(2-hydroxypropoxy)phenyl]-methylpropanone, oligo 2-hydroxy-2-methyl-1-[4-(1-methyl-vinyl)phenyl]propanone, 2-hydroxy-1-[4[4-(2-hydroxy-2-methyl-propionyl)-benzyl]-phenyl]-2-methyl-propan-1-one, 2-methyl-4′-(methylthio)-2-morpholino-propiophenone, 2-benzyl-2-(dimethylamino)-4-morpholinobutyrophenone, 2-(4-methylbenzyl)-2-(dimethylamino)-4-morpholinobutyrophenone, 2,2-dimethoxy-2-phenyl-acetophenone, 2,2-diethoxy-2-phenyl-acetophenone, 2,2-diethoxy-1-phenylethanone diethoxyacetophenone, 2-isopropoxy-2-phenylacetophenone, 2-N-butoxy-2-phenylacetophenone, 2-isobutoxy-2-phenylacetophenone, bis(2,4,6-trimethylbenzoyl)-(2,4-bis-pentyloxyphenyl)phosphine oxide, ethyl(2,4,6-trimethylbenzoyl)phenyl phosphinate, diphenyl-(2,4,6-trimethylbenzoyl)phosphine oxide, phenyl-bis-(2,4,6-trimethylbenzoyl)phosphine oxide, 4′-(tert-butyl)-2,2,2-trichloroacetophenone, 4′-(phenoxy)-2,2-dichloroacetophenone, 2-(4-methoxyphenyl)-4,6-bis-(trichloromethyl)-s-triazine, 2,4-bis(trichloromethyl)-6-p-methoxystyril-s-triazine, 2,4-bis(trichloromethyl)-6-(3,4-dimethoxy)-styril-s-triazine, 2,4-bis(trichloromethyl)-6-(3,4-dimethoxy)-styril-s-triazine, 1-phenyl-1,2-propandione-2-(o-ethoxy-carbonyl) oxime, 1-[4-(phenylthio)phenyl]-octan-1,2-dione-2-(o-benzoyloxime), benzophenone, 4-methylbenzophenone, 3,3′-dimethyl-4-methoxybenzophenone, benzophenone-2-carboxy-(tetraethoxy)acrylate, 4-phenylbenzophenone, methyl 2-benzoylbenzoate, 1-{-4-[benzoylphenylsulfo]phenyl}-2-methyl-2-(4-methylphenylsulfonyl)-propan-1-one, 2-isopropylthioxanthone, 4-isopropylthioxanthone, 2,4-diethylthioxanthone, 2-chlorothioxanthone, 2,4-dimethylthioxanthone, 1-chloro-4-propoxythioxanthone, 2,4-diisopropylthioxanthone, methyl phenylglyoxylate, 2-ethylanthraquinone, 2-ethyl-9,10-anthracene dione, polyethylene glycol-bis-[(4-acethylphenyl)-piperazine propionate], 3-benzoyl-7-methoxy-2H-chromen-2-one and combinations thereof. Preferably the second monomer is selected from the group constituted by monomers of (meth)acrylate groups, comprising: tricyclodecane dimethanol diacrylate, 3-[2,2-dimethyl-1-oxo-3-[(1-oxo-2-propenyl)oxy]propoxy]-2,2-dimethylpropyl acrylate, dihydro dicyclopenta dienyl acrylate, pentaerythritol triacrylate, pentaerythritol tetramethacrylate, dipropylene glycol diacrylate, ditrimethylol propane tetraacrylate, isobornyl acrylate, dipentaerythritol hexacrylate, tert-butyl acrylate, trimethylol propane triacrylate, tripropylenglycol diacrylate, bisphenol A diacrylate n-ethoxylate (with 1<n<=10), bisphenol A diacrylate, 3,3,5-trimethylcyclohexyl acrylate, (5-ethyl-1,3-dioxan-5-yl)methyl acrylate, trimethylol propane triacrylate n-ethoxylate (with 1<n<=10), neopentylglycol diacrylate, triethylene glycol diacrylate, phenoxyethyl acrylate, tetra hydro furfuryl acrylate, isobutyl acrylate, dodecyl acrylate, butyl acrylate, isodecyl acrylate, dodecafluoroeptyl acrylate, hexahydro-4,7-methan-1H-indenyl acrylate, acrylic acid or from the group constituted by acrylamide monomers, comprising N,N-dimethylacrylamide, isobutylmethylol acrylamide acrylate, 4-acryloylmorpholine, N-isopropylacrylamide, N,N-dimethylamino propylacrylamide, N-hydroxyethylacrylamide, N,N-diethyl acrylamide, tris[2-(acryloyloxy)ethyl] isocyanurate.

Alternatively, the second monomer is selected from the group of monomers containing urethane groups and exhibiting (meth)acrylate functionality. Further characteristics and advantages of the invention will be more evident from the detailed description of some preferred, but not exclusive, embodiments of a method for the three-dimensional printing of fiber composite materials according to the present invention.

### BRIEF DESCRIPTION OF THE DRAWINGS

Such description will be set forth hereunder with reference to the accompanying drawings provided by way of example only and thus not limiting, in which:

FIGS. 1a-1c show three subsequent moments of the depositing step of a continuous filiform element of the method for three-dimensional printing of composite materials according to the present invention, in which the energy source transmits energy directly to the continuous phase until the initiation temperature of a frontal polymerization reaction is reached;

FIGS. 2a-2c show three subsequent moments of the depositing step of a continuous filiform element of the method for three-dimensional printing of composite materials according to the present invention, in which the energy source transmits energy to the dispersed phase which consequently increases its temperature by transmitting heat to the continuous phase until the initiation temperature of a frontal polymerization reaction is reached;

FIGS. 3a-3c show three subsequent moments of the depositing step of a continuous filiform element of the method for three-dimensional printing of composite materials according to the present invention, in which the energy source transmits energy to the dispersed phase, in the specific case in which the dispersed phase contains some material which is discontinuous or pulverulent;

FIG. 4 shows an equipment for three-dimensional printing of composite materials that implements the method according to the present invention; and

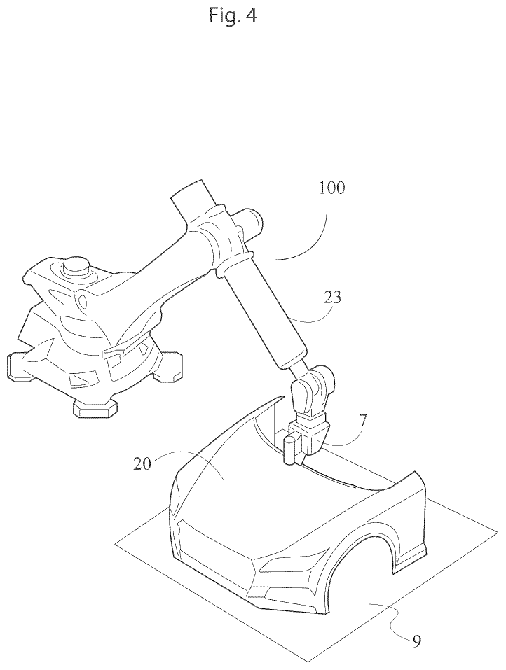

FIG. 5 shows a table with some, possible formulations of the continuous phase.

### DETAILED DESCRIPTION OF EMBODIMENTS OF THE INVENTION

With reference to the figures, an equipment for three-dimensional printing of fiber composite materials is denoted in its entirety by the reference number 100. In particular, the equipment 100 is suitable for printing a composite material from a filiform continuous element 4 constituted by at least one continuous phase 2 and at least one dispersed phase 3.

Generally, said at least one dispersed phase 3 comprises fiber material selected from carbon fibers, glass fibers, poly paraphenylene terephthalamide fibers, ultra-high molecular weight polyethylene (UHMWPE) fibers, poly arylether ketone (PAEK) fibers, poly paraphenylene-2,6-benzobisoxazole fibers, poly ether sulfone (PES) fibers, beryllium fibers, tungsten fibers, carbon nanofibers, silicon carbide (SiC) fibers, boron fibers, poly imide (PI) fibers, poly benzimidazole fibers, poly oxymethylene (POM) fibers, poly ether imide (PEI) fibers, fibers made of metal alloy, basalt fibers, natural fibers and combinations thereof.

Generally, the fibers comprised in the dispersed phase 3 can be one or more continuous or long fibers joined together to form a continuous element or they can be short fibers (not joined together).

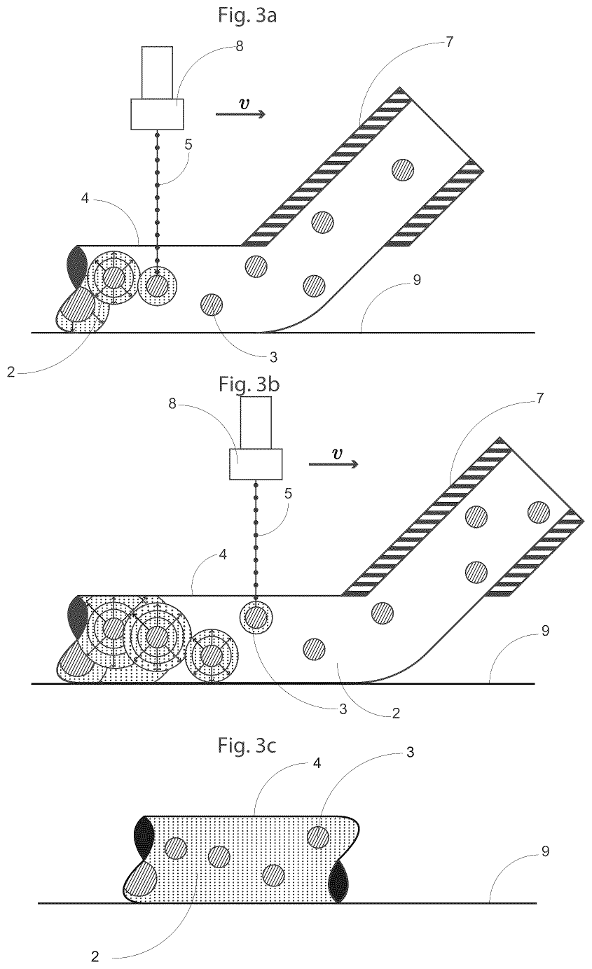

The dispersed phase 3 can also comprise, as in the case of FIGS. 3a-3c, pulverulent material or material in the form of nanostructures configured for specific tasks such as receiving energy, preferably by electromagnetic radiation, from a suitable energy source 8 to raise the temperature of the dispersed phase 3 and/or continuous phase 2 in order to initiate a frontal polymerization reaction.

The pulverulent material is selected from carbon black, silicon dioxide, graphite, titanium oxide, boron nitride, zirconium oxide, calcium carbonate, calcium phosphate, molybdenum disulfide, lignin and combinations thereof.

The material in the form of nanostructures is selected from graphene, single-walled carbon nanofibers, multi-walled carbon nanofibers, fullerene, clay nanoplates and combinations thereof.

Preferably, the continuous phase comprises at least one first compound comprising:
a thermal initiator in an amount greater than or equal to about 0.001 mol % and lower than or equal to about 10 mol %;
a first monomer in an amount greater than or equal to about 20 mol % and lower than or equal to about 99.9 mol %;
a cationic initiator in an amount greater than or equal to about 0.001 mol % and lower than or equal to about 10 mol %; and
a first diluent in an amount greater than or equal to about 0 mol % and lower than or equal to about 70 mol %.

Preferably, the thermal initiator is selected from the group constituted by: 1,1,2,2-tetraphenyl-1,2-ethanediol (TPED), benzopinacol bistrimethylsilyl ether (TPED-Si), dimethylsulfonylperoxide (DMSP), tert-butylperoxide (TBPO), tert-butylcyclohexylperoxodicarbonate (TBC-PDC), benzoylperoxide (BPO), azo-bis(isobutyronitrile) (AIBN) and combinations thereof. Preferably, the first monomer is selected from the group constituted by: bisphenol A diglycidylether (DGEBA), bisphenol F diglycidylether (DGEBF), 3,4-epoxycyclohexylmethyl 3,4-epoxycyclohexanecarboxylate (CE), 4-vinyl-1-cyclohexan-1,2-epoxide, vinylcyclohexene bioxide, 4,5-epoxy tetrahydrophthalic acid diglycidylester, glycidyl methacrylate, pentaerythritol glycidyl ether, trimethylolpropane triglycidyl ether, 2-(3,4-epoxycyclohexyl)ethyltrimethoxysilane, poly(ethylenglycol) diglycidyl ether, epoxidized soybean oil, N,N-diglycidyl-4-glycidyloxyaniline, bis-3,4-epoxycyclohexylmethyladipate, diglycidyl 1,2-cyclohexane dicarboxylate, allyl glycidyl ether, phenyl glycidyl ether, diglycidyl 4,5-epoxycyclohexan-1,2-dicarboxylate, 4,4″-methylenebis[N,N-bis(2,3-epoxypropyl)aniline], tris(2,3-epoxypropyl) isocyanurate, m-(2,3-epoxypropoxy)-N,N-bis(2,3-epoxypropyl)aniline, p-(2,3-epoxypropoxy)-N,N-bis(2,3-epoxypropyl)aniline, triethoxy(3-glycidyl oxypropyl)silane, 1,2-epoxycyclohexane, tris(4-hydroxyphenyl)methane triglycidylether, epoxy-phenolic resins (including those derived from novolacs), 9-[2-(2-methoxyethoxy)ethoxy]-9-[3-(oxyranylmethoxy)propyl]-2,5,8,10,13,16-hexaoxa-9-silaheptadecane, glycidyl stearate, resorcinol diglycidylether, 1,4-butanediol diglycidyl ether (BDGE), vinyl ethers, epoxy-phenolic resins (including those derived from dicyclopentadiene), carboxyl-terminated butadiene acrylonitrile rubber (CTBN), epoxy-terminated butadiene acrylonitrile rubber (ETBN) and combinations thereof; preferably the cationic initiator is selected from [4-(4-diphenylsulfoniumphenyl)sulfonylphenyl]-diphenylsulfonium trihexafluorophosphate, (4-methylphenyl) [4-(2-methylpropyl)phenyl]iodonium hexafluorophosphate, (9-oxofluoren-2-yl)-phenyliodonium hexafluoroantimonate, [4-(4-diphenylsulfoniumphenyl)sulfonylphenyl]-diphenylsulfonium hexafluoroantimonate, [4-[(2- hydroxytetradecyl)oxy]phenyl] phenyliodonium hexafluoroantimonate, 4-octyloxydiphenyliodonium hexafluoroantimonate, 10-(4-phenylphenyl)-2-propan-2-ylthioxanthen-10-ium-9-one hexafluorophosphate, bis(4-dodecylphenyl)iodonium hexaflurorantimonate, bis-(4-t-butylphenyl)iodonium hexafluorophosphate, bis[4-(tert-butyl)phenyl]iodonium tetra(nonafluoro-tert-butoxy) aluminate, diphenyl(4-phenylthio)phenylsulfonium hexafluorophosphate, diphenyliodonium hexafluorophosphate, bis(4-methylphenyl)iodonium hexafluorophosphate, (4-methylphenyl)[4-(propan-2-yl)phenyl]iodonium tetrakis(2,3,4,5,6-pentafluorophenyl) borate and combinations thereof.

Preferably, the first diluent is selected from the group constituted by: polyfunctional glycidyl ethers, monofunctional aliphatic glycidyl ethers, monofunctional aromatic glycidyl ethers, 3-ethyl-3-oxethanemethanol (EOM), 3-Methyl-3-oxethanemethanol, 1,4-bis(glycidyloxy)benzene (CHDGE), 1,6-hexanediol diglycidylether (HDDGE), neopentyl glycol diglycidyl ether (NPDGE), 1,4-butanediol diglycidyl ether (BDGE) and combinations thereof and the like.

Furthermore, other additives and reinforcements can be present in the continuous filiform element 4.

According to another embodiment, the continuous filiform element 4 and in particular its continuous phase 2 can comprise a photosensitizing material configured to receive energy supplied by electromagnetic radiation 5 in the ultraviolet or visible spectrum by an appropriate energy source 8, so as to chemically activating said photosensitizer in turn activating a cationic initiator to generate an exothermic reaction adapted for raising the temperature of the continuous phase to the initiation temperature of a frontal polymerization reaction.

Preferably, the photosensitizing material is present in an amount greater than or equal to about 0.001 mol % and lower or equal to about 5 mol %.

The photosensitizing material is selected in the group consisting of: anthracene, perylene, benzophenone, 9,10-diethoxyanthracene, 2,2-dimethoxy-2-phenylacetophenone, 2-isopropylthioxanthone (ITX), thioxanthen-9-one, vinylcarbazole and combinations thereof.

The equipment 100 comprises a feeding head 7 of a continuous filiform element 4, a supporting surface 9 on which the continuous filiform element 4 is deposited to make the preferably three-dimensional object 20 to be printed, a relative movement assembly between the feeding head 7 and the supporting surface 9, so as to exert a pull on the continuous filiform element 4, an energy source 8 configured to supply a predetermined amount of energy to the continuous filiform element 4.

Specifically, the energy source 8 is configured to supply a predetermined amount of energy to the continuous filiform element 4 such that its continuous phase is brought to an initiation temperature such that a front of frontal polymerization reaction is initiated in the continuous phase itself.

The frontal polymerization reaction could be a reaction of RICFP (Radical Induced Cationic Frontal Polymerization) type. The rapid formation of molecular networks with a high degree of conversion (monomer-polymer conversion), that results from frontal polymerization reactions, allows this type of reaction to be considered a valid alternative to traditional processes used in the production of polymer matrix composite materials. In addition, the frontal polymerization reactions take advantage of the heat generated by the reaction itself to generate a self-propagating reaction front, thus making it more energy efficient and making the reaction products more homogeneous.

The feeding head 7 is advantageously supported by a movement assembly for the relative movement between the feeding head 7 itself and the object 20 to be printed.

During the feeding of the continuous filiform element 4, the movement assembly exerts a tensile force on the continuous filiform element 4 and thus also on the continuous fibers contained therein.

Consequently, this tensile force is also transferred to the fibers.

Note that this tensile force causes the same continuous filiform element 4 to be fed into the feeding head 7.

Consequently, the higher the relative speed, the faster the feed of the filiform continuous element 4.

According to an alternative embodiment, the feeding of the continuous filiform element 4 occurs by extruding it from the feeding head 7.

Advantageously, the feeding of the continuous filiform element 4 occurs by extrusion of the same in the case where said dispersed phase 3 comprises discontinuous, pulverulent fibers or nanostructures.

In further detail, the movement means comprise at least one machine with numerically controlled motion on at least three axes.

According to a first embodiment not shown in the figures, the numerically controlled machine comprises a motorized arm 23 to support the feeding head 7 mentioned above at a respective end portion.

The motorized arm 23, which is not described or illustrated in detail since it is of known type, is adapted to move the head in at least three spatial axes, by orienting the feeding head according to any position relative to the object 20.

Note that the supporting surface 9, which is arranged under the feeding head 7, can in turn be moved close to/away from the feeding head 7. Said supporting surface 9 can be constituted by said continuous filiform element 4 previously deposited in the course of making the three-dimensional object 20.

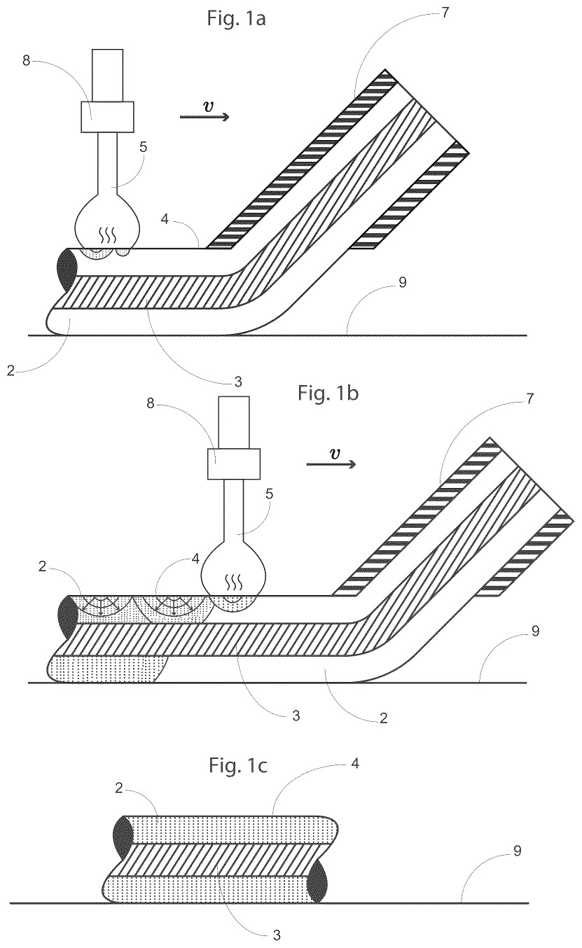

According to a first embodiment shown in FIGS. 1a-1c, the energy source 8 can be constituted by a heat emission source provided for heating the continuous filiform element 4.

The energy sources 8 of this type are generally based on providing a flow of hot air 5.

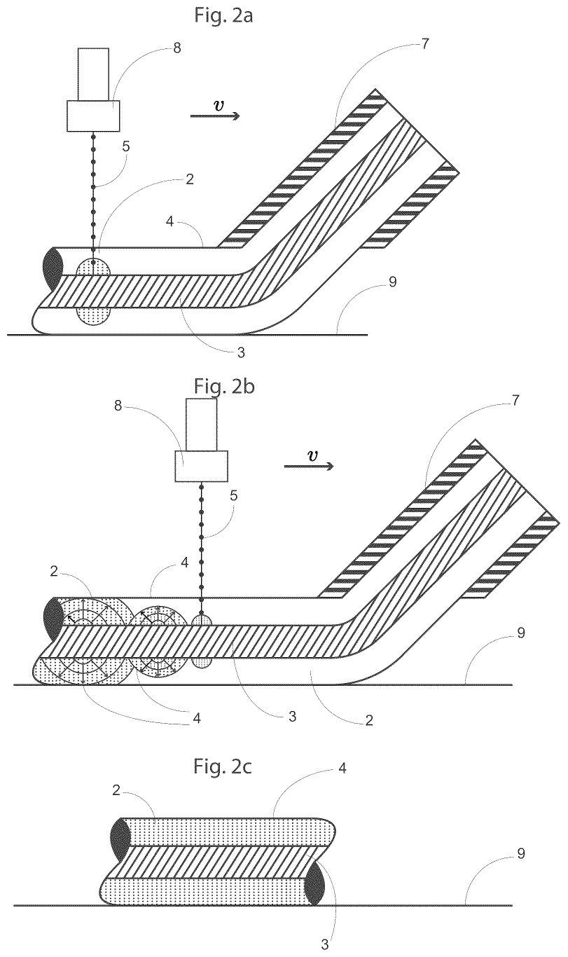

Alternatively, the energy source 8 can be a source of electromagnetic radiation (FIGS. 2a-2c; 3a-3c). In this case, the energy source 8 can, for example, consist of at least one source of electromagnetic radiation in the infrared or ultraviolet field, depending on the type of material which the continuous filiform element 4 is made of.

The energy source 8 is located downstream of the feeding head and is configured to supply energy to the continuous filiform element 4 at the supporting surface 9.

In any case, the energy source 8 is configured to transfer energy to the continuous filiform element 4 or at least one of its phases substantially throughout the deposition process and at different points in the deposition element itself.

In other words, the energy source 8 is configured to repeatedly subject the continuous filiform element 4 to a predetermined amount of energy during its deposition.

According to an alternative embodiment, the energy source 8 is configured to continuously subject the continuous filiform element 4 to a predetermined amount of energy during its deposition; as for example shown in FIGS. 1a-3c. Note that said amount of energy can be changed during the depositing step. Conveniently, said amount of energy can be modulated depending on the speed of said relative movement.

Therefore, the delivery of energy to the continuous filiform element 4 occurring during the deposition of the continuous filiform element 4 on the supporting surface 9 according to a precise path of the continuous filiform element 4 occurs at different points of the continuous filiform element 4 itself, thus supporting the frontal polymerization reaction.

In the embodiment shown in the figures, preferably upstream of the energy source 8, there is a cutting tool not shown in the figures, which can be represented by at least one movable blade moving closer/away to cut the continuous filiform element 4.

According to this embodiment, the cutting tool acts on the continuous filiform element 4 after one of its parts has been applied on the supporting surface 9.

The present invention relates to a method for three-dimensional printing of composite materials provided with at least one dispersed phase, comprising at least one, preferably thermally conductive material, and at least one continuous phase reacting by means of front polymerization reactions, which comprises the steps of:
feeding at least one continuous filiform element 4 to a feeding head 7; and;
depositing said continuous filiform element 4 on a supporting surface 9;
subjecting the continuous filiform element 4 to such an amount of energy as to bring said at least one continuous phase to an initiation temperature so as to initiate a front of frontal polymerization reaction in said at least one continuous phase; the polymerization reaction could be a reaction of RICFP (Radical Induced Cationic Frontal Polymerization) type. The rapid formation of molecular networks with a high degree of conversion (monomer-polymer conversion), that results from frontal polymerization RICFP reactions, allows this type of reaction to be considered a valid alternative to traditional processes used in the production of polymer matrix composite materials. In addition, the frontal polymerization RICFP reactions take advantage of the heat generated by the reaction itself to form a self-propagating reaction front, thus making it more energy efficient and making the reaction products more homogeneous.

Supplying, to said continuous filiform element 4, said amount of energy in a repeated manner and at different positions along its extent, resulting in the initiation of more than one front of frontal polymerization during the depositing step.

The feeding and depositing steps are carried out by exerting a dragging force on the continuous filiform element 4 achieved by relative movement between the feeding head 7 and the three-dimensional object 20 to be printed or between the feeding head 7 and the supporting surface 9.

In other words, by moving the feeding head 7 by the action of the numerically controlled machine, the continuous filiform element 4 is gradually deposited on the supporting surface 9 or on a previously made portion of said three-dimensional object 20, which is produced due to the feeding of the continuous filiform element 4.

In some cases, the feeding of the continuous filiform element 4 occurs by extruding it from the feeding head 7.

More in detail, to implement the printing process, the continuous filiform element 4 coming out of the nozzle of the feeding head 7 is initially spread on the respective supporting surface 9.

At this point, the continuous filiform element 4, and in particular its end resting on the supporting surface 9, is invested by a predetermined amount of energy such as to initiate a front of frontal polymerization and create a fixing point between the continuous filiform element 4 and the supporting surface 9.

The deposition of the continuous filiform element 4 can then progress according to predefined paths and trajectories adapted to form the three-dimensional object 20 to be printed.

The fixing point thus formed allows the continuous filiform element 4 to be arranged on the supporting surface 9 according to a precise path and to draw, as the numerically controlled machine moves, the object 20 to be printed.

The feeding head 7 is thus moved by the numerically controlled machine according to a predetermined path that defines the object 20 to be printed.

This path is determined by suitable management software that is not described in the present description since it is not within the scope of the invention.

At the end of the printing process, or anyhow when the continuous feeding of the continuous filiform element 4 must be interrupted, the filiform element or a derivative thereof is cut by the cutting mechanism.

The transformation of the continuous filiform element 4 into a composite material is initiated initially near the fixing point between the supporting surface 9 and the continuous filiform element 4 (FIGS. 1a, 2a, 3a).

In all cases, the transformation occurs by supplying a predetermined amount of energy to the continuous filiform element 4, which is adapted for increasing the temperature of the continuous phase until the temperature for initiating frontal polymerization reactions is reached.

In particular, if the continuous filiform element 4 does not have a dispersed phase that can effectively increase its temperature once subjected to energy by electromagnetic radiation, such as for example glass fibers, silicon oxide, zirconium oxide, the energy that invests the continuous filiform element 4 is advantageously provided by the use of energy sources operating by convection or conduction.

In this case, the heat provided results in the direct increase of the temperature of the continuous phase so as to bring it above an initiation temperature of a frontal polymerization reaction. Preferably, the polymerization reaction is a reaction of the RICFP (Radical Induced Cationic Frontal Polymerization) type.

When the temperature of the continuous phase 2 is equal or greater than the initiation temperature, the initiation of a frontal polymerization reaction capable of propagating inside the continuous filiform element 4 is obtained.

The deposition of the continuous filiform element 4 according to the preset trajectory subsequently shifts the point of application of energy in the form of heat, thus generating subsequent initiations of frontal polymerization reactions (FIG. 1b), therefore resulting in an overall frontal polymerization reaction that thereby propagates and is sustained at a rate comparable with that of deposition of the continuous filiform element 4.

Applying energy to the continuous filiform element 4 can occur at very close time intervals or continuously, as, for example, shown in FIGS. 1a-3c.

Preferably, applying energy in the form of heat to the filiform element occurs throughout the duration of the depositing step of the continuous filiform element 4.

Alternatively, if the continuous filiform element 4 has a dispersed phase capable of effectively increasing its temperature once subjected to energy by electromagnetic radiation, such as for example carbon fiber, basalt fiber, carbon black, graphene, carbon nanotubes, carbon nanofibers, metal alloys, advantageously the energy investing the continuous filiform element 4 is supplied by means of electromagnetic radiation preferably emitted by a source of electromagnetic radiation in the infrared or visible spectrum.

In this case, as in the examples in FIGS. 2a-3c, the energy 5 supplied by the energy source 8 raises the temperature of the dispersed phase 3 which, preferably by conduction, increases the temperature of the continuous phase so as to raise it above an initiation temperature of a frontal polymerization reaction.

When the temperature of the continuous phase 2 is equal or greater than the initiation temperature, the initiation of a frontal polymerization reaction capable of propagating inside the continuous filiform element 4 is obtained.

The deposition of the continuous filiform element 4 according to the preset trajectory subsequently shifts the point of application of energy, thus generating subsequent initiations of frontal polymerization reactions, therefore resulting in an overall frontal polymerization reaction that thereby propagates and is sustained at a rate comparable with that of deposition of the continuous filiform element 4.

Applying energy to the continuous filiform element 4 can occur at very close time intervals or continuously.

Preferably, applying energy in the form of heat to the filiform element occurs throughout the depositing step of the continuous filiform element 4.

Alternatively, if the continuous filiform element 4 has a continuous phase comprising a sensitizer, such as for example 2-isopropylthioxanthone, thioxanthen-9-one, vinylcarbazole, the energy investing the continuous filiform element 4 is administered by means of electromagnetic radiation preferably emitted by a source of electromagnetic radiation and selected in the ultraviolet or visible spectrum.

In this case, the energy supplied chemically activates the sensitizer in turn activating a cationic initiator to generate an exothermic reaction adapted to raise the temperature of the continuous phase to the initiation temperature of a frontal polymerization reaction.

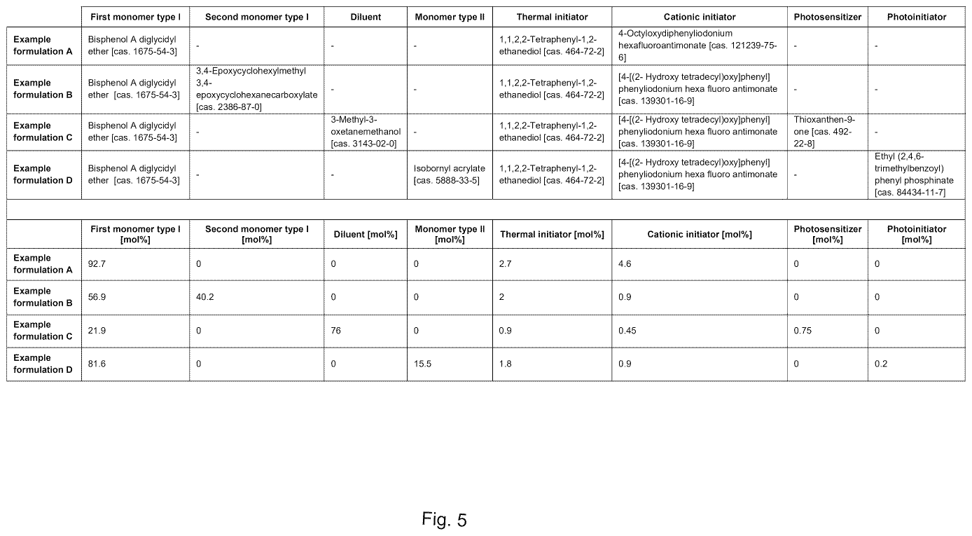

A table with some continuous phase formulations is depicted in FIG. 5 as an example; in the aforesaid table for each component the type and its percent molar fraction are depicted, if any.

The invention, as clearly discernible from the above description, allows for overcoming the limitations of known three-dimensional printing processes of fiber composite materials, in terms of materials and/or processes that can be used.

Furthermore, once the alternative polymerization mechanisms (e.g., frontal polymerization) conveniently used for the production of composite materials with a high degree of homogeneity are known, the present invention succeeds in enabling overcoming the achievable process speeds that are limited and inherent in these types of chemical reactions. Therefore the present invention is proposed as an enabling solution for the effective use of these types of monomers and chemical reactions within three-dimensional printing processes of fiber composite materials.

Several changes can be made to the embodiments described in detail, all anyhow remaining within the scope of protection of the invention as defined by the following claims.

1. Method for the three-dimensional printing of fiber composite materials, comprising the steps of:
feeding at least one continuous filiform element, to a feeding head said continuous filiform element comprising at least one dispersed phase and comprising at least one continuous phase reacting by means of frontal polymerization reactions;
depositing said continuous filiform element on a supporting surface.
subjecting said continuous filiform element to such an amount of energy as to bring said at least one continuous phase to an initiation temperature so as to initiate a front of frontal polymerization reaction in said at least one continuous phase;
supplying to said continuous filiform element said amount of energy in a repeated manner and at different positions along its extent, during the depositing step, so as to initiate different polymerization fronts.

2. Method for the three-dimensional printing of fiber composite materials according to claim 1, wherein said amount of energy is applied directly to said continuous phase.

3. Method for the three-dimensional printing of fiber composite materials according to claim 1, said amount of energy is applied to said dispersed phase, so as to bring said at least one continuous phase to said initiation temperature.

4. Method for the three-dimensional printing of fiber composite materials according to claim 1, wherein said method comprises:
spreading at least one end of the continuous filiform element on a respective supporting surface;
subjecting said end of said continuous filiform element; to said amount of energy so as to bring said at least one continuous phase to an initiation temperature so as to initiate a front of frontal polymerization reaction in said at least one continuous phase;
displacing said feeding head relative to a fixing point according to a predetermined path that defines the object to be printed.

5. Method for the three-dimensional printing of fiber composite materials according to claim 1, wherein said feeding and depositing steps are implemented by exerting a tensile force on the continuous filiform element by relative movement between a respective feeding head and said supporting surface or by extrusion of the continuous filiform element.

6. Method for the three-dimensional printing of composite materials according to claim 1, wherein said at least one dispersed phase comprises fiber material selected from carbon fibers, glass fibers, poly paraphenylene terephthalamide fibers, ultra-high molecular weight polyethylene (UHMWPE) fibers, poly arylether ketone (PAEK) fibers, poly paraphenylene-2,6-benzobisoxazole fibers, poly ether sulfone (PES) fibers, beryllium fibers, tungsten fibers, carbon nanofibers, silicon carbide (SiC) fibers, boron fibers, poly imide (PI) fibers, poly benzimidazole fibers, poly oxymethylene (POM) fibers, poly ether imide (PEI) fibers, fibers made of metal alloy, basalt fibers, natural fibers, and combinations thereof.

7. Method for the three-dimensional printing of composite materials according to claim 1, wherein said at least one dispersed phase comprises pulverulent material or material in form of nanostructures;
said pulverulent material being selected from carbon black, silicon dioxide, graphite, titanium oxide, boron nitride, zirconium oxide, calcium carbonate, calcium phosphate, molybdenum disulfide, lignin and combinations thereof; said material in form of nanostructures being selected from graphene, single-wall carbon nanotubes, multi-wall carbon nanotubes, fullerene, clay nanoplates and combinations thereof.

8. Method for the three-dimensional printing of composite materials according to claim 1, wherein said continuous phase comprises at least one first compound comprising:
a thermal initiator in an amount greater than or equal to about 0.001 mol % and lower than or equal to about 10 mol %;
a first monomer in an amount greater than or equal to about 20 mol % and lower than or equal to about 99.9 mol %;
a cationic initiator in an amount greater than or equal to about 0.001 mol % and lower than or equal to about 10 mol %; and
a first diluent in an amount greater than or equal to about 0 mol % and lower than or equal to about 70 mol %.

9. Method for the three-dimensional printing of composite materials according to claim 8, wherein:
said thermal initiator is selected from the group constituted by: 1,1,2,2-tetraphenyl-1,2-ethanediol (TPED), benzopinacol bistrimethylsilyl ether (TPED-Si), dimethylsulfonylperoxide (DMSP), tert-butylperoxide (TBPO), tert-butylcyclohexylperoxodicarbonate (TBC-PDC), benzoylperoxide (BPO), azo-bis(isobutyronitrile) (AIBN) and combinations thereof;
the monomer is selected from the group constituted by: bisphenol A diglycidylether (DGEBA), bisphenol F diglycidylether (DGEBF), 3,4-epoxycyclohexylmethyl 3,4-epoxycyclohexanecarboxylate (CE), 4-vinyl-1-cyclohexan-1,2-epoxide, vinylcyclohexene bioxide, 4,5-epoxy tetrahydrophthalic acid diglycidylester, glycidyl methacrylate, pentaerythritol glycidyl ether, trimethylolpropane triglycidyl ether, 2-(3,4-epoxycyclohexyl)ethyltrimethoxysilane, poly(ethylenglycol) diglycidyl ether, epoxidized soybean oil, N,N-diglycidyl-4-glycidyloxyaniline, bis-3,4-epoxycyclohexylmethyladipate, diglycidyl 1,2-cyclohexane dicarboxylate, allyl glycidyl ether, phenyl glycidyl ether, diglycidyl 4,5-epoxycyclohexan-1,2-dicarboxylate, 4,4″-methylenebis[N,N-bis(2,3-epoxypropyl)aniline], tris(2,3-epoxypropyl) isocyanurate, m-(2,3-epoxypropoxy)-N,N-bis(2,3-epoxypropyl)aniline, p-(2,3-epoxypropoxy)-N,N-bis(2,3-epoxypropyl)aniline, triethoxy(3-glycidyl oxypropyl)silane, 1,2-epoxycyclohexane, tris(4-hydroxyphenyl)methane triglycidylether, epoxy-phenolic resins (including those derived from novolacs), 9-[2-(2-methoxyethoxy)ethoxy]-9-[3-(oxyranylmethoxy)propyl]-2,5,8,10,13,16-hexaoxa-9-silaheptadecane, glycidyl stearate, resorcinol diglycidylether, 1,4-butanediol diglycidyl ether (BDGE), vinyl ethers, epoxy-phenolic resins (including those derived from dicyclopentadiene), carboxyl-terminated butadiene acrylonitrile rubber (CTBN), epoxy-terminated butadiene acrylonitrile rubber (ETBN) and combinations thereof,
the cationic initiator is selected from the group constituted by: [4-(4-diphenylsulfoniumphenyl)sulfonylphenyl]-diphenylsulfonium trihexafluorophosphate, (4-methylphenyl) [4-(2-methylpropyl)phenyl]iodonium hexafluorophosphate, (9-oxofluoren-2-yl)-phenyliodonium hexafluoroantimonate, [4-(4-diphenylsulfoniumphenyl)sulfonylphenyl]-diphenylsulfonium hexafluoroantimonate, [4-[(2-hydroxytetradecyl)oxy]phenyl] phenyliodonium hexafluoroantimonate, 4-octyloxydiphenyliodonium hexafluoroantimonate, 10-(4-phenylphenyl)-2-propan-2-ylthioxanthen-10-ium-9-one hexafluorophosphate, bis(4-dodecylphenyl)iodonium hexaflurorantimonate, bis-(4-t-butylphenyl)iodonium hexafluorophosphate, bis[4-(tert-butyl)phenyl]iodonium tetra(nonafluoro-tert-butoxy) aluminate, diphenyl(4-phenylthio)phenylsulfonium hexafluorophosphate, diphenyliodonium hexafluorophosphate, bis(4-methylphenyl)iodonium hexafluorophosphate, (4-methylphenyl)[4-(propan-2-yl)phenyl]iodonium tetrakis(2,3,4,5,6-pentafluorophenyl) borate and combinations thereof; and
said diluent is selected from the group constituted by: polyfunctional glycidyl ethers, monofunctional aliphatic glycidyl ethers, monofunctional aromatic glycidyl ethers, 3-ethyl-3-oxethanemethanol (EOM), 3-Methyl-3-oxethanemethanol, 1,4-bis(glycidyloxy)benzene (CHDGE), 1,6-hexanediol diglycidylether (HDDGE), neopentyl glycol diglycidyl ether (NPDGE), 1,4-butanediol diglycidyl ether (BDGE) and combinations thereof.

10. Method for the three-dimensional printing of composite materials according to claim 1, wherein said continuous phase comprises at least one photo-sensitizing material.

11. Method for the three-dimensional printing of composite materials according to claim 10, wherein said photo-sensitizing material is present in an amount greater than or equal to about 0.001 mol % and lower than or equal to about 5 mol %.

12. Method for the three-dimensional printing of composite materials according to claim 10, wherein said photo-sensitizing material is selected from the group consisting of: anthracene, perylene, benzophenone, 9,10-diethoxyanthracene, 2,2-dimethoxy-2-phenylacetophenone, 2-isopropylthioxanthone (ITX), thioxanthen-9-one, vinylcarbazole and combinations thereof.

13. Method for the three-dimensional printing of composite materials according to claim 1, wherein said energy is supplied by means of sources of electromagnetic radiation.

14. Method for the three-dimensional printing of composite materials according to claim 1, wherein said energy is supplied by energy sources operating by convection.

15. Method for the three-dimensional printing of composite materials according to claim 1, wherein energy is supplied by electromagnetic radiation in the infrared spectrum.

16. Method for the three-dimensional printing of composite materials according to claim 1, wherein energy. is supplied by electromagnetic radiation in the ultraviolet spectrum.

17. Method for the three-dimensional printing of composite materials according to claim 1, wherein said continuous phase comprises at least one second compound comprising:
a photo-initiator in an amount greater than or equal to about 0.001 mol % and lower than or equal to about 10 mol %;
a second monomer in an amount greater than or equal to about 20 mol % and lower than or equal to about 99.9 mol.

18. Method for the three-dimensional printing of composite materials according to claim 17, wherein said second compound further comprises:
a compound with synergistic action in an amount greater than 0 mol % and lower than or equal to about 50 mol %;
a second diluent in an amount greater than 0 mol % and lower than or equal to about 70 mol %.

19. Method for the three-dimensional printing of composite materials according to claim 17, wherein said second compound is present in an amount greater than or equal to about 0.1 mol % and lower than or equal to 20 mol %.

20. Method for the three-dimensional printing of composite materials according to claim 17, wherein said second compound is subjected to a preliminary polymerization step upstream of the feeding head.

21. Method for the three-dimensional printing of composite materials according to claim 17, wherein said second diluent is selected from the group constituted by: neopentyl acrylate, 3-methyl-1,5-pentanediol diacrylate, 1,6-hexanediol diacrylate, 2-ethylhexyl acrylate, 2-methoxyethyl acrylate and combinations thereof.

22. Method for the three-dimensional printing of composite materials according to claim 17, wherein said compound with synergistic action is selected from the group constituted by molecules exhibiting amine groups comprising triethylamine, tri-N-butylamine, 2-dimethylaminoethanol, N-methyldiethanolamine, triethanolamine, 2-(dimethylamino)ethyl benzoate, ethyl 4-(dimethylamino)benzoate, 2-ethylhexyl-4-dimethylamino-benzoate, isoamyl-4-(dimethylamino)-benzoate, 2-butoxyethyl-4-(dimethylamino)-benzoate, N-phenylglycine, 4,4′,4″-tris(dimethylamino)-triphenylmethane and combinations thereof or by the group constituted by molecules exhibiting thiol groups, comprising butyl 3-mercaptopropionate, trimethylolpropane tris(2-mercaptoacetate), trimethylolpropane-tris(2-mercaptopropionate), 2-benzothiazolethiol, 2-benzimidazolol, 1,6-hexane bis(3-mercaptopropionate), di[trimethylolpropane tri(3-mercaptopropionate)], pentaerythritol tetrakis (3-mercaptobutyrate), 1,4-butanediyl bis(3-mercaptobutyrate), trimethylol propane tris (3-mercaptobutyrate) and combinations thereof.

23. Method for the three-dimensional printing of composite materials according to claim 17, wherein said photo-initiator is selected from the group constituted by:
2-hydroxy-2-methyl-propiophenone, 2,2-dimethyl-2-hydroxyacetophenone, 2-hydroxy-2-methyl-1-phenylpropanone, 2-hydroxy-2-methyl-4′-tert-butyl-propiophenone, 2-hydroxy-2-methyl-1-(4-tertbutylphenyl)-propanone, 1-hydroxycyclohexylphenylketone, 2-hydroxy-4′-(2-hydroxyethoxy)-2-methyl-propiophenone, 2-hydroxy-[4′-(2-hydroxypropoxy)]-2-methyl-propiophenone, 2-hydroxy-[4′-(2-hydroxypropoxy)phenyl]-2methylpropanone, oligo 2-hydroxy-2-methyl-1-[4-(1-methyl-vinyl)phenyl]propanone, 2-hydroxy-1-[4[4-(2-hydroxy-2-methyl-propionyl)-benzyl]-phenyl]-2-methyl-propan-1-one, 2-methyl-4′-(methylthio)-2-morpholino-propiophenone, 2-benzyl-2-(dimethylamino)-4-morpholinobutyrophenone, 2-(4-methylbenzyl)-2-(dimethylamino)-4-morpholinobutyrophenone, 2,2-dimethoxy-2-phenyl-acetophenone, 2,2-diethoxy-2-phenyl-acetophenone, 2,2-diethoxy-1-phenylethanone diethoxyacetophenone, 2-isopropoxy-2-phenylacetophenone, 2-n-butoxy-2-phenylacetophenone, 2-isobutoxy-2-phenylacetophenone, bis(2,4,6-trimethylbenzoyl)-(2,4-bis-pentyloxyphenyl)phosphine oxide, ethyl(2,4,6-trimethylbenzoyl)phenyl phosphinate, diphenyl-(2,4,6-trimethylbenzoyl)phosphine oxide, phenyl-bis-(2,4,6-trimethylbenzoyl)phosphine oxide, 4′-(tert-butyl)-2,2,2-trichloroacetophenone, 4′-(phenoxy)-2,2-dichloroacetophenone, 2-(4-methoxyphenyl)-4,6-bis-(trichloromethyl)-s-triazine, 2,4-bis(trichloromethyl)-6-p-methoxystyril-s-triazine, 2,4-bis(trichloromethyl)-6-(3,4-dimethoxy)-styril-s-triazine, 2,4-bis(trichloromethyl)-6-(3,4-dimethoxy)-styril-s-triazine, 1-phenyl-1,2-propandione-2-(o-ethoxy-carbonyl) oxime, 1-[4-(phenylthio)phenyl]-octan-1,2-dione-2-(o-benzoyloxime), benzophenone, 4-methylbenzophenone, 3,3′-dimethyl-4-methoxybenzophenone, benzophenone-2-carboxy-(tetraethoxy)acrylate, 4-phenylbenzophenone, methyl 2-benzoylbenzoate, 1-{-4-[benzoylphenylsulfo]phenyl}-2-methyl-2-(4-methylphenylsulfonyl)-propan-1-one, 2-isopropylthioxanthone, 4-isopropylthioxanthone, 2,4-diethylthioxanthone, 2-chlorothioxanthone, 2,4-dimethylthioxanthone, 1-chloro-4-propoxythioxanthone, 2,4-diisopropylthioxanthone, methyl phenylglyoxylate, 2-ethylanthraquinone, 2-ethyl-9,10-anthracene dione, polyethylene glycol-bis-[(4-acethylphenyl)-piperazine propionate], 3-benzoyl-7-methoxy-2H-chromen-2-one and combinations thereof;

24. Method for the three-dimensional printing of composite materials according to claim 17, wherein said second monomer is selected from the group constituted by monomers exhibiting (meth)acrylate groups, comprising: tricyclodecane dimethanol diacrylate, 3-[2,2-dimethyl-1-oxo-3-[(1-oxo-2-propenyl)oxy]propoxy]-2,2-dimethylpropyl acrylate, dihydro dicyclopenta dienyl acrylate, pentaerythritol triacrylate, pentaerythritol tetramethacrylate, dipropylene glycol diacrylate, ditrimethylol propane tetraacrylate, isobornyl acrylate, dipentaerythritol hexacrylate, tert-butyl acrylate, trimethylol propane triacrylate, tripropylenglycol diacrylate, bisphenol A diacrylate n-ethoxylate (with 1<n<=10), bisphenol A diacrylate, 3,3,5- trimethylcyclohexyl acrylate, (5- ethyl-1,3-dioxan-5-yl)methyl acrylate, trimethylol propane triacrylate n-ethoxylate (with 1<n <=10), neopentylglycol diacrylate, triethylene glycol diacrylate, phenoxyethyl acrylate, tetra hydro furfuryl acrylate, isobutyl acrylate, dodecyl acrylate, butyl acrylate, isodecyl acrylate, dodecafluoroeptyl acrylate, hexahydro-4,7-methan-1H-indenyl acrylate, acrylic acid or from the group constituted by acrylamide monomers, comprising N,N-dimethylacrylamide, isobutylmethylol acrylamide acrylate, 4-acryloylmorpholine, N-isopropylacrylamide, N,N-dimethylamino propylacrylamide, N-hydroxyethylacrylamide, N,N-diethyl acrylamide, tris[2-(acryloyloxy)ethyl] isocyanurate and combinations thereof.

25. Method for the three-dimensional printing of composite materials according to claim 17, wherein said second monomer is selected from the group of monomers containing urethane groups and exhibiting (meth)acrylate functionality.
